(19) United States
(12) Patent Application Publication
(10) Pub. No.: US 2013/0332263 A1
(43) Pub. Date: Dec. 12, 2013

(54) COMPUTER IMPLEMENTED METHODS AND APPARATUS FOR PUBLISHING A MARKETING CAMPAIGN USING AN ONLINE SOCIAL NETWORK

(71) Applicant: SALESFORCE.COM, INC., San Francisco, CA (US)

(72) Inventors: Darshil Vora, San Jose, CA (US); Siddharth Bansal, Bartlett, IL (US)

(73) Assignee: salesforce.com, inc., San Francisco, CA (US)

(21) Appl. No.: 13/804,877

(22) Filed: Mar. 14, 2013

Related U.S. Application Data
(60) Provisional application No. 61/658,776, filed on Jun. 12, 2012.
(60) Provisional application No. 61/699,647, filed on Sep. 11, 2012.

(51) Int. Cl. G06Q 30/02

(52) U.S. Cl. CPC G06Q 30/0245
USPC 705/14.44

(57) ABSTRACT

Disclosed are methods, apparatus, systems, and computer readable storage media for publishing a marketing campaign on an online social network. A CRM server accesses a marketing campaign record in a database and transmits marketing campaign data to be published on an online social network. The CRM server also receives data related to users interacting with the published marketing campaign. The CRM server can store the user-related data. In some implementations, the user-related data can also be analyzed.

### PRIORITY DATA

This patent document claims priority to co-pending and commonly assigned U.S. Provisional Patent Application No. 61/658,776, titled “System and Method for Managing a Marketing Campaign Published to a Social Network”, by D. Vora, filed on Jun. 12, 2012 and claims priority to U.S. Provisional Patent Application No. 61/699,647, titled “Unified Marketing”, by S. Bansal, filed on Sep. 11, 2012, both of which are hereby incorporated by reference in their entirety and for all purposes.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This patent document relates generally to the use of database objects such as customer relationship management (CRM) records to conduct a marketing campaign using online social networks, and more specifically, to creating or updating such database records when users interact with the social network marketing campaign.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

Management of online marketing campaigns can be provided in a cloud computing context. Online marketing campaigns may also be provided on online social networks. However, using conventional online marketing campaign management techniques, it is difficult to efficiently obtain and manage data of users on online social networks who are interacting with the marketing campaign. For example, users of online social networks who are interacting with content posted on an online social network may be identified as leads, opportunities, contacts, cases, and/or accounts. However, extracting, storing, and analyzing information of the users can be difficult.

### BRIEF DESCRIPTION OF THE DRAWINGS

The included drawings are for illustrative purposes and serve only to provide examples of possible structures and operations for the disclosed inventive systems, apparatus, methods and computer readable media for publishing a marketing campaign using an online social network. These drawings in no way limit any changes in form and detail that may be made by one skilled in the art without departing from the spirit and scope of the disclosed implementations.

FIG. 1 shows a system diagram of an example of architectural components 100 for publishing a marketing campaign to an online social network based on data from a marketing campaign record according to some implementations.

FIG. 2 shows a system diagram of an example of architectural components 200 for publishing a marketing campaign to multiple online social networks based on data from a marketing campaign record according to some implementations.

FIG. 3 shows a flowchart of an example of a computer implemented method 300 for publishing a marketing campaign using an online social network in accordance with some implementations.

FIG. 4 shows a flowchart of an example of a computer implemented method 400 for publishing a marketing campaign using an online social network in accordance with some implementations.

FIG. 5 shows an example of a graphical user interface (GUI) 500 for creating an online marketing campaign record, according to some implementations.

FIG. 6A shows an example of a data structure in a customer relationship management (CRM) system in accordance with some implementations.

FIG. 6B shows an example of a data structure in a CRM system in accordance with some implementations.

FIG. 7 shows an example of a marketing campaign published on an online social network in accordance with some implementations.

FIG. 8 shows a flowchart of an example of a computer implemented method 800 for publishing a marketing campaign using an online social network in accordance with some implementations.

FIG. 9 shows a system diagram of an example of architectural components 900 for publishing a marketing campaign to an online social network based on data from a marketing campaign record according to some implementations.

FIG. 10 shows an example of a GUI 1000 for providing details on a marketing campaign record, according to some implementations.

FIG. 11A shows a block diagram of an example of an environment 10 in which an on-demand database service can be used in accordance with some implementations.

FIG. 11B shows a block diagram of an example of some implementations of elements of FIG. 11A and various possible interconnections between these elements.

FIG. 12A shows a system diagram illustrating an example of architectural components of an on-demand database service environment 1200 according to some implementations.

FIG. 12B shows a system diagram further illustrating an example of architectural components of an on-demand database service environment according to some implementations.

### DETAILED DESCRIPTION

Examples of systems, apparatus, and methods according to the disclosed implementations are described in this section. These examples are being provided solely to add context and aid in the understanding of the disclosed implementations. It will thus be apparent to one skilled in the art that implementations may be practiced without some or all of these specific details. In other instances, certain process/method operations, also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Various implementations described or referenced herein are directed to different systems, apparatus, methods and computer-readable storage media for creating, managing, and analyzing marketing campaigns published to online social networks such as Facebook®, Twitter®, Youtube®, Google+®, LinkedIn®, and other services. Marketing campaigns published on the social networks may be managed and tracked by a customer relationship management (CRM) system, for instance, using products and services offered by salesforce.com, inc. Data, such as user interactions, related to marketing campaigns may be stored by the CRM system and published onto the appropriate social networks. Moreover, the CRM system may generate and store information associated with potential and existing leads, accounts, opportunities, cases, and contacts. Thus, information on the effectiveness of campaigns and information on the users of the social networks interacting with the campaign can be created and managed in such an environment without having to install software locally, that is, on computing devices of users accessing the CRM system.

For example, a user may use a computing device to provide data regarding a marketing campaign to be published on online social networks. The data may include text, hyperlinks, videos, images, or other types of data. Accordingly, the appropriate types of data may be transmitted to the online social networks to publish the marketing campaigns. Users of the online social networks may then interact with the campaigns. For example, users may post comments or indicate that they “like” a post related to the campaign. Accordingly, the comments and number of likes may be stored by the CRM system. Additionally, the CRM system may also obtain and store data associated with the user profiles on the users interacting with the campaign post. For example, user names, real names, contact information, geographic location, education and employment information, and other types of data associated with the users may be stored by the CRM system.

The CRM system may also analyze the comments to determine if users are reacting negatively to the campaign. Certain users with particular demographics may be identified as a user to follow-up with regarding the campaign. For example, a user posting a negative comment, and also having a large number of followers or friends, may be identified as a user that should receive extra attention. Accordingly, a case record may be generated for a customer service representative. A second online marketing campaign may also be published onto a selected online social network in response to the reaction of the original campaign.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

Online social networks are increasingly becoming a common way to facilitate communication among people who can be recognized as users of a social networking system. Some online social networks can be implemented in various settings, including organizations, e.g., enterprises such as companies or business partnerships, academic institutions, or groups within such an organization.

In some online social networks, users can access one or more information feeds, which include information updates presented as items or entries in the feed. Such a feed item can include a single information update or a collection of individual information updates. A feed item can include various types of data including character-based data, audio data, image data and/or video data. For example, a post related to an online marketing campaign may appear as a feed item. An information feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “information feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different information feeds. A second user following a first user and a record can receive the feed items associated with the first user and the record for display in the second user's news feed, which is another type of information feed. In some implementations, the feed items from any number of followed users and records can be combined into a single information feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

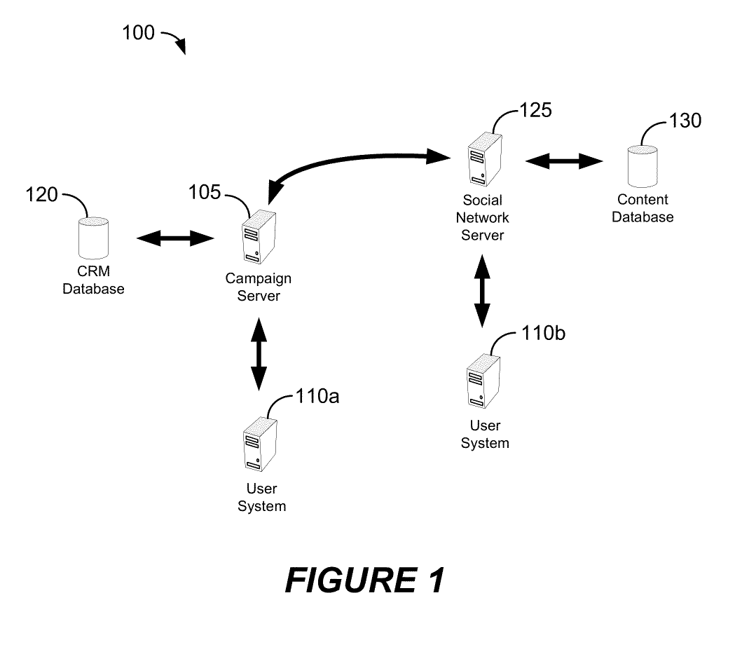

FIG. 1 shows a system diagram illustrating an example of architectural components 100 for publishing a marketing campaign to an online social network based on data from a marketing campaign record according to some implementations. Architectural components 100 in FIG. 1 may provide communications to be transmitted among a variety of different hardware and/or software components. For example, architectural components 100 may include User System 110a, Campaign Server 105 obtaining and analyzing data from other components, customer relationship management (CRM) Database 120 storing CRM records such as leads, opportunities, contacts, cases, and accounts, User System 110b, Social Network Server 125 provided as part of a social networking system such as LinkedIn° or Facebook®, and Content Database 130 storing data such as user profiles, content including posts, and user interactions associated with Social Network Server 125.

In an implementation, Campaign Server 105, CRM Database 120, Social Network Server 125, and Content Database 130 may be managed by the same entity. In other implementations, management of the different architectural components 100 may be spread across multiple entities. For example, CRM Database 120 and Campaign Server 105 may be operated by an entity providing CRM services and Social Network Server 125 and Content Database 130 may be operated by an entity providing an online social network service.

In some implementations, User System 110a may communicate with Campaign Server 105. Campaign Server 105 may further communicate with additional architectural components, such as CRM Database 120 and Social Network Server 125. In an implementation, Campaign Server 105 may store login credentials, such as a username and a password, to access other architectural components. Campaign Server 105 may also communicate with other architectural components which store login credentials, and therefore, may obtain the login credentials from other architectural components. In other implementations, Campaign Server 105 may determine if User System 110a is already logged into another architectural component, such as Social Network Server 125, and then transmit or receive data from the particular component. Additionally, Campaign Server 105 may prompt User System 110a to provide login credentials if necessary to obtain access to an architectural component of architectural components 100. Campaign Server 105 may also use an application programming interface (API) to connect to Social Network Server 125.

Accordingly, various components are able to communicate with each other over the Internet or a combination of networks including the Internet. For example, in an implementation, Campaign Server 105 may transmit data to and process data received from User System 110a. Campaign Server 105 may store data received from User System 110a into CRM Database 120. Moreover, Campaign Server 105 may obtain data from CRM Database 120 in response to processing data obtained from User System 110a. Campaign Server 105 may also transmit data to or obtain data from Social Network Server 125. Social Network Server 125 may transmit data to and process data received from Campaign Server 105. Accordingly, Social Network Server 125 may store data received from Campaign Server 105 into Content Database 130 as well as transmit data from Content Database 130 to Campaign Server 110a. Social Network Server 125 may also further communicate with User System 110b.

As an example, Campaign Server 105 may receive, from User System 110a, data regarding a social marketing campaign to be published to one or more social media channels of an online social network on Social Network Server 125. The data regarding the social marketing campaign may be stored by Campaign Server 105 on CRM Database 120. Additionally, Campaign Server 105 may obtain data regarding the social marketing campaign from CRM Database 120 upon a request to publish the campaign from User System 110a. For example, the social marketing campaign data may already be stored in CRM Database 120 and published onto Social Network Server 125 when User System 110a decides it is ready to be published. As such, the data for the social marketing campaign may be transmitted by Campaign Server 105 to Social Network Server 125 so that it may be published onto an online social network. In some implementations, Social Network Server 125 may store data regarding the social marketing campaign on Content Database 130. Accordingly, User System 110b may access Social Network Server 125 and interact, such as post a comment or indicate that the campaign is “liked,” with the published social marketing campaign. The interaction with the campaign may be stored within Content Database 130 and associated with the campaign publication. Campaign Server 105 may then retrieve data associated with the published social marketing campaign, such as the interaction and details on users who interacted with the campaign. The data may be stored in CRM Database 120. For example, data related to the campaign itself, such as how many users posted comments or indicated that they viewed the campaign positively, timeframe or timestamps of the posted comments or interactions with the campaign, as well as data regarding the actual users (e.g., username, real name, employer, occupation, geographic location, interests, etc.) may be stored in CRM Database 120. In some implementations, the geographic locations of the users may be provided by mobile computing devices of users of the online social networks. User System 110a may request to view the stored data within CRM Database 120. As such, the effectiveness of the campaign and information on users interacting with the campaign may be obtained.

User System 110a and 110b may be any type of computing device. For example, User Systems 110a and 110b may be portable electronic devices such as smartphones, tablets, laptops, etc. User Systems 110a and 110b may be another server or a desktop computer. Additionally, User Systems 110a and 110b may be different types of computing devices. For example, user System 110a may be a desktop computer whereas user System 110b may be a smartphone.

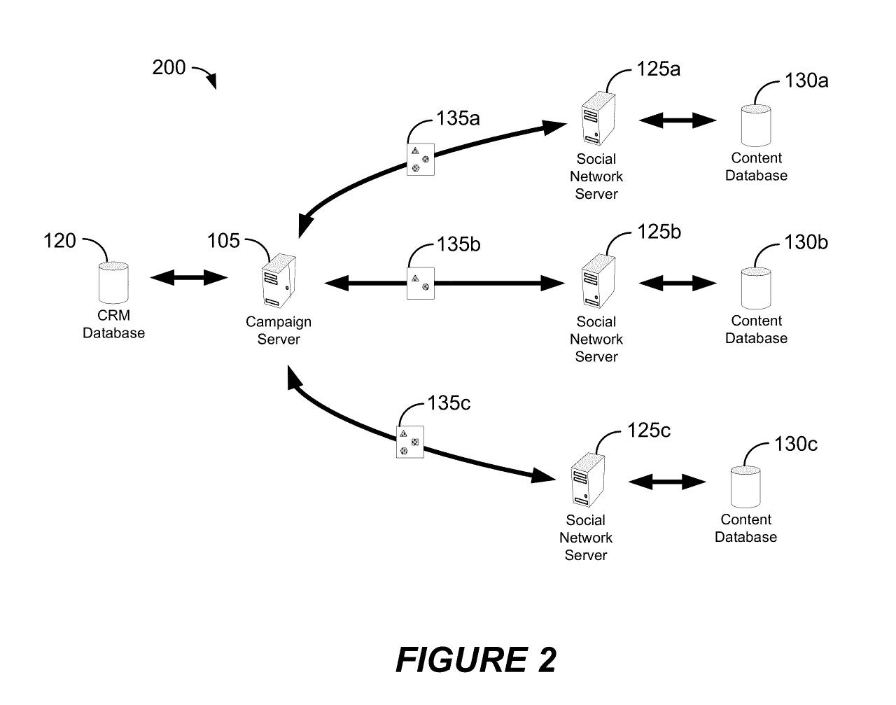

FIG. 2 shows a system diagram illustrating an example of architectural components 200 for publishing a marketing campaign to multiple online social networks based on data from a marketing campaign record according to some implementations. Architectural components 200 in FIG. 2 may also provide communications to be transmitted among a variety of different hardware and/or software components. For example, architectural components 200 may include the same components as architectural components 100 as well as multiple Social Network Servers 125a, 125b, and 125c. Each of social network servers may be a separate online social network. Accordingly, Campaign Server 105 may publish data regarding an online social marketing campaign across a variety of online social networks. The same campaign or different campaigns may be published across the Social Network Servers 125a, 125b, and 125c. In some implementations, multiple online social marketing campaigns may also be posted onto a single online social network.

Campaign Server 105 in FIG. 2 may also transmit and obtain different types of data among the different social networks on Social Network Servers 125a-c. As such, Communication 135a between Campaign Server 105 and Social Network Server 125a may include different types of data than Communication 135b between Campaign Server 105 and Social Network Server 125b and Communication 135c between Campaign Server 105 and Social Network Server 125c.

For example, Social Network Server 125a may only include content incorporating textual messages and a graphical image. Social Network 125b may only include content including graphical images. Furthermore, Social Network Server 125c may only include content including a video and textual message. Accordingly, different types of data may be transmitted to the Social Network Servers 125a-c in order to publish an online social marketing campaign on the respective online social networks. Data regarding the same campaign or different campaigns may be transmitted. Accordingly, the same campaign may include a variety of graphical, video, code, text, captions, descriptions, audio, hyperlinks, files, polls, surveys, games, author names or other types of data that may be used to publish on each Social Network Server 125a-c. Alternatively, different campaigns may include different types of data.

Additionally, data obtained from Social Network Servers 125a-c and stored by Campaign Server 105 into CRM Database 120 may also be different. For example, data obtained from Social Network Server 125a may include usernames, user comments related to the campaign on the social network, and email addresses. Data obtained from Social Network Server 125b may include usernames and comments. Furthermore, data obtained from Social Network Server 125c may include usernames, comments, and employment information. The obtained data may be stored in CRM Database 120.

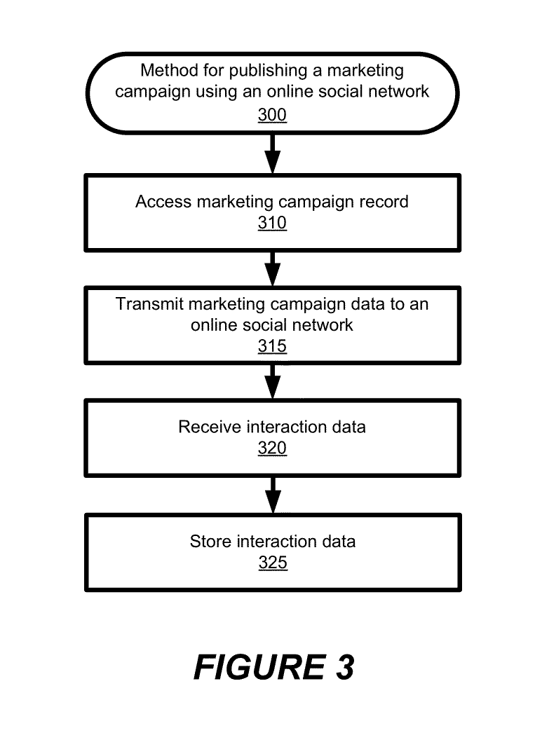

FIG. 3 shows a flowchart of an example of a method 300 for publishing a marketing campaign to an online social network based on data from a marketing campaign record according to some implementations. Method 300 (and other methods described herein) may be implemented by the architectural components of FIGS. 1 and 2. In various implementations, blocks may be reordered, omitted, combined, or split into additional blocks for method 300, as well as other methods described herein.

In block 310, a server, such as Campaign Server 105 may access data from a marketing campaign record at a server associated with a customer relationship management (CRM) platform, such as CRM Database 120. The data may be obtained from a user system such as User System 110a. In an implementation, User System 110a may provide data to Campaign Server 105 which may be stored in CRM Database 120 and transmitted to Social Network Servers 125a-c in block 315.

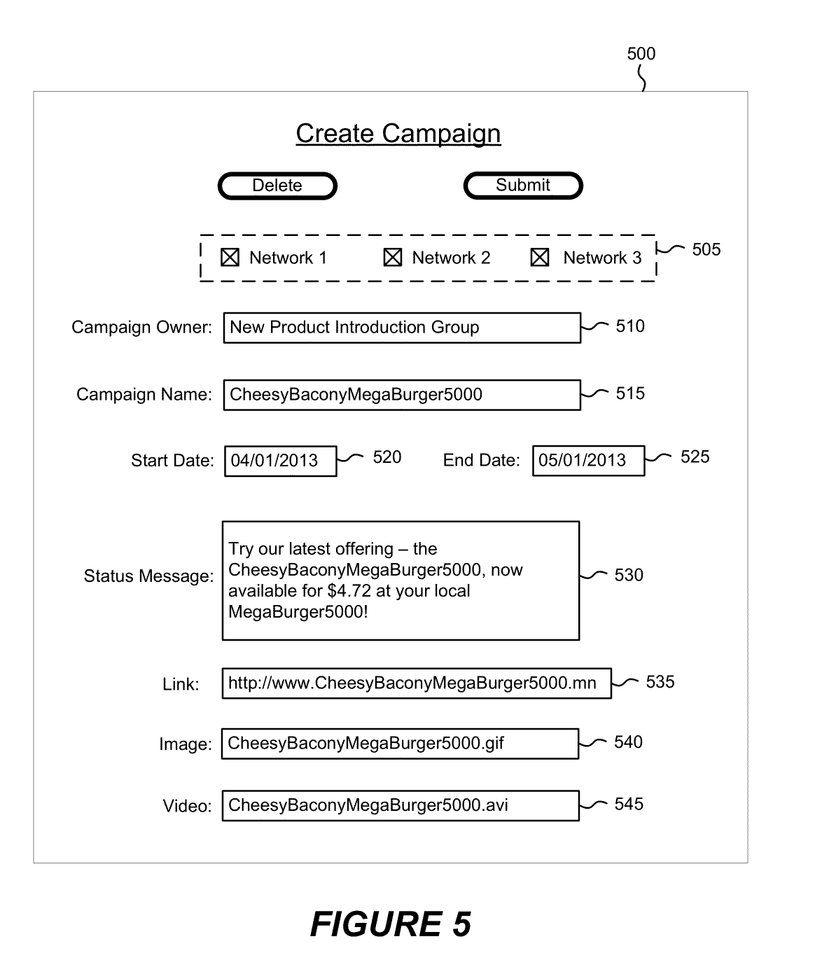

For example, FIG. 5 shows an example of a Graphical User Interface (GUI) used to provide data for a marketing campaign record as displayed on a display device according to some implementations. In FIG. 5, the GUI shows Campaign Record Form 500 including Online Social Network Selection 505 and fields Campaign Owner 510, Campaign Name 515, Start Date 520, End Date 525, Message 530, Link 535, Image 540, and Video 545. In this example, multiple inputs 505-545 may be selected or specified, but depending on the selected online social networks, a subset of the total data may be transmitted for the published campaign on each network. For example, Network 1 may be an online social network that only publishes content including messages and links. Network 2 may be an online social network that publishes videos and messages. Network 3 may be an online social network that publishes images, messages, and links. Accordingly, data from Message 530 and Link 535 may be selected to be transmitted to Network 1. Data from Message 530 and Video 545 may be transmitted to Network 2. Data from Message 530, Link 535, and Image 540 may be transmitted to Network 3. Thus, though all of the data is stored in the same campaign record, only subsets of the data used by the social networks within the campaign record are selected and transmitted. In other implementations, each social network may have its own independent fields to fill out. The data may be stored in a record associated with the campaign or each social network for the campaign may have its own record. Campaigns may be published on the indicated online social networks upon submission of the Campaign Record Form 500. In other implementations, the data associated with the Campaign Record Form 500 may be stored in CRM Database 120 and later published onto the appropriate online social networks.

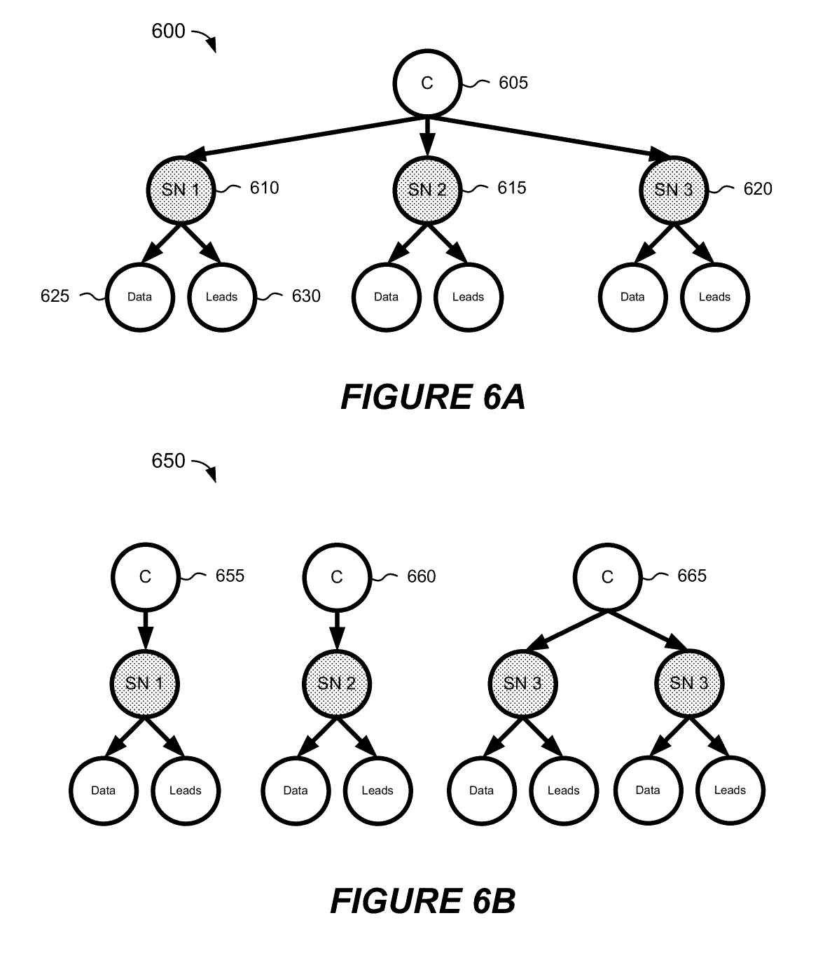

In an implementation, each campaign on a social network may be associated with its own identifier or unique identification. Accordingly, the data in CRM Database 120 may be organized in a variety of ways. FIGS. 6A and 6B show examples of organized data structures in various parent-child relationships within CRM Database 120. In FIG. 6A, a single campaign 605 may have an identifier, such as a unique number, name, or combination of numbers and letters. Campaign 605 may be an object stored in CRM Database 120 that is associated with content 610, 615, and 620, each representing sub-campaigns or representations of campaign 605, posted on three different social networks. Each of the sub-campaigns may also be objects in CRM Database 120. The campaign or sub-campaigns sent to the three different social networks may also be identified with a unique identification. In an implementation, the identifier, as well as other types of data, associated with the campaign or sub-campaigns on the online social networks may be received from the online social networks when the marketing campaign is published. For example a post name, post ID, author name, publication timestamp, and post information (caption, description, web address, content, status, etc.) may be received. Additionally, each sub-campaign object 610-620 may include a reference to Campaign 605 as a parent. Accordingly, the three sub-campaigns are linked via the reference to the identifier associated with Campaign 605. Moreover, each sub-campaign may be linked with interaction data, including Data 625 related to the campaign post and Leads 630 related to the users interacting with the campaign post. As such, the data retrieved from the social networks are associated with the identifier of the respective social network it came from and/or the campaign post. Moreover, the interaction data received from the social networks may be stored in a CRM object in the CRM database. In an implementation, objects may be associated with a record in a table of a database, with records representing each campaign, and each record including a unique identifier. Content posted on social networks as sub-campaigns may be associated with a second table, with each sub-campaign with its own unique identifier and the record for each sub-campaign including a reference to the record corresponding to the campaign. Data retrieved from the social network and stored in CRM Database 120 may also include references to records associated with sub-campaigns or campaigns. In an implementation, CRM objects may be case records, account records, opportunity records, lead records, and contact records.

In the example of FIG. 6B, Campaigns 655, 660, and 665 may be published on separate online social networking websites. Campaigns 655 and 660 each only include one content post on a social network. However, Campaign 665 includes 2 content posts, both on the same social network. Accordingly, Campaign 665 may include multiple sub-campaigns on the same social network.

In an implementation, campaigns may have a Start Date 520 and End Date 525, as shown in the GUI of FIG. 5. Accordingly, User System 110a may provide data for a campaign, but set the start date in the future. Campaign Server 105 may publish the marketing campaign on the appropriate social networking websites on the indicated date. Moreover, End Date 525 may signify the end of the campaign. Campaign Server 105 may close comments or interactions with the campaign on online social networks, delete the campaign from online social networks, or stop collecting interaction data and user data from the online social networks upon the indicated end date of the campaign.

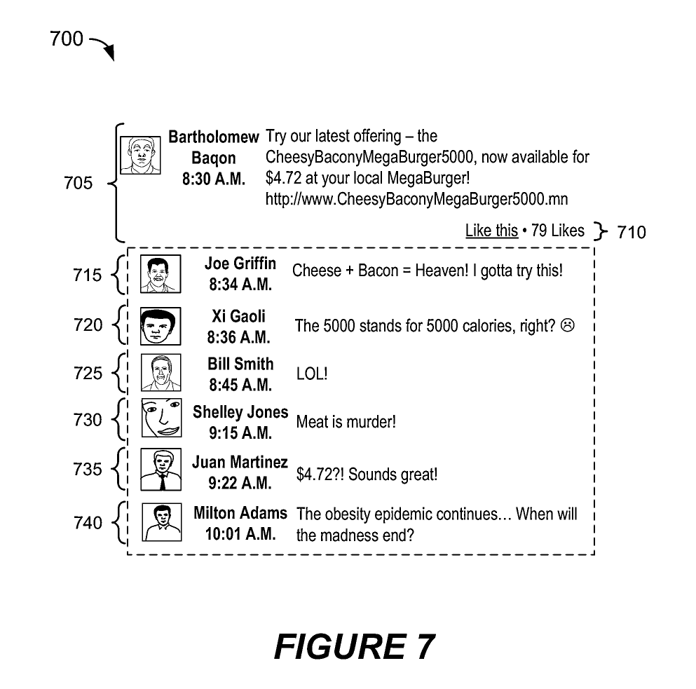

In block 315, data associated with the marketing campaign may be transmitted to an online social network. FIG. 7 shows an example of a campaign 700 published on an online social network, such as Network 1 in FIG. 5. In FIG. 7, Campaign Post 705 includes data from Message 530 and Link 535 of the campaign record form, which are part of the campaign record. Campaign Post 700 does not include video or image data associated with the campaign record because, as previously explained, Network 1 only uses messages and links for content published on the online social network. Campaign 700 also collects a variety of interaction data 710-740. Likes Indicator 710 represents the number of users who “like” the campaign. Comments 715-740 are comments posted by users of the online social network who are responding to the campaign's publication.

In blocks 320 and 325, interaction data may be received and stored, for example, in CRM Database 120. Interaction data may include comments 715-740 and the number of “likes” indicated in 710. Interaction data may also include information regarding users on the online social network, such as usernames, first and last names, number of followers or friends or connections, contact information (email, telephone, fax, etc.), employment information, education, interests, time or timestamps of comments or likes, and other types of data available on a profile of a user. Accordingly, interaction data may be stored in CRM Database 120 in a record associated, for example via identifiers, with the online marketing campaign. As such, the impact of the campaign may be determined by receiving the number of comments or likes, or analyzing the comments. Additionally, interaction data may include user profile data that may be stored in CRM Database 120. In some implementations, user data may be stored as potential leads, sales, or marketing opportunities. For example, users responding to the marketing campaign on the social network may be identified as leads to follow up with regarding the campaign, company, or product associated with the campaign content posted on the social network. Accordingly, information on the users may be stored in CRM Database 120.

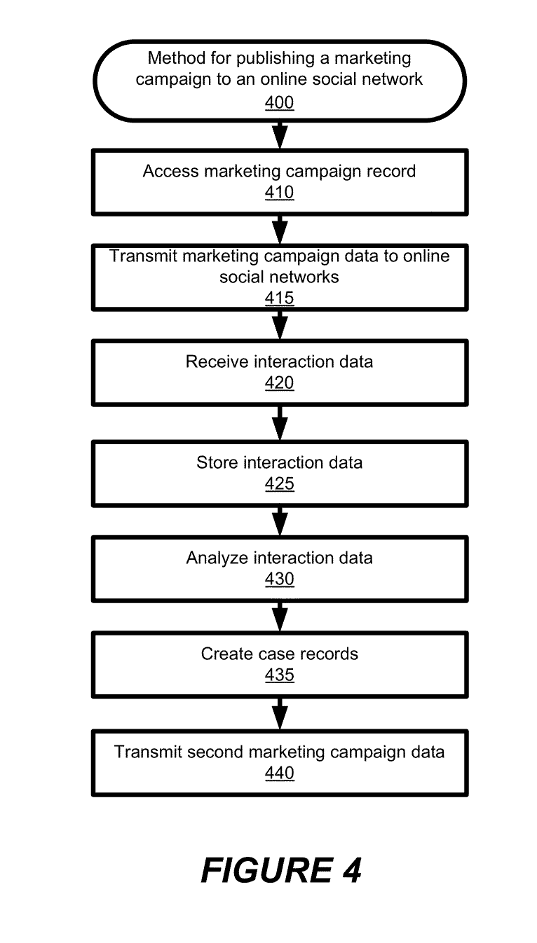

FIG. 4 shows a flowchart of an example of a method 400 for publishing a marketing campaign to an online social network based on data from a marketing campaign record according to some implementations. In block 410, marketing campaign information may be obtained, as previously discussed with block 310. In block 415, the marketing campaign data may be transmitted to multiple online social networks, as previously discussed. In block 420, interaction data may be received from the multiple online social networks. For example, Campaign Server 105 may receive an indication from User System 110a to obtain interaction data. Accordingly, upon receipt of the indication, Campaign Server 105 may transmit the identifier associated with the sub-campaigns on each social network and obtain all of the interaction data related to the campaign post. In other implementations, Campaign Server 105 may obtain interaction data at periodic intervals or at set times. In block 425, the interaction data may be stored in CRM Database 120.

In block 430, the interaction data may be analyzed. In an implementation, Campaign Server 105 may analyze the comments and other interactions associated with the marketing campaign on the online social networks. For example, in FIG. 7, Comments 715-740 and Likes Indicator 710 are stored in interaction data. The interaction data may be analyzed, for example by keyword searching, to determine if Comments 715-740 include comments with particular sentiments or opinions. For example, in FIG. 7, Comment 715 by a user posting “Cheese+Bacon=Heaven! I gotta try this!” may be determined to be a positive sentiment regarding the campaign. Comment 735 may also be indicated as having a positive sentiment. However, Comment 720 from a user posting “The 5000 stands for 5000 calories, right?” with a sad face may indicate a negative sentiment. Comments 730 and 740 may also be indicated as having a negative sentiment. Additionally, information on the users interacting with the campaign post may also be stored.

In block 435, a case record CRM object may be created. In some implementations, the case record CRM object may be stored as a record of a table in a database. Case records may be created to address a variety of situations. For example, a case record may be created to alert User System 110a to a campaign post with a negative sentiment. In another implementation, a case record may be created in response to campaign posts with positive sentiment. In another implementation, a case record may be created if a comment has a negative sentiment and the user making the negative comment has a number of followers on the social network exceeding a threshold number of followers. Accordingly, influential users on the social network who are responding negatively to the campaign may be identified and a case record may be created to address issues related to the campaign, product, or corporation. For example, a user with 100 followers posting a negative comment in response to the campaign may not lead to a case record being generated. However, a user with 500 followers posting a negative comment in response to the campaign may lead to a case record being generated.

In some implementations, the created case record may include interaction data and the sentiment of the user's comment. For example, a case record may include a user's username, contact information (email, phone numbers, etc.), number of followers on the social network, and comment in response to the campaign.

In block 440, Campaign Server 105 may transmit marketing campaign data associated with a second campaign. In an implementation, data for a second campaign may be stored in CRM Database 120 and transmitted to a social network in response to a threshold of negative or positive comments or likes associated with a first campaign. Accordingly, a campaign may be selected by Campaign Server 105 and transmitted to an online social network in response to the reaction of the first campaign.

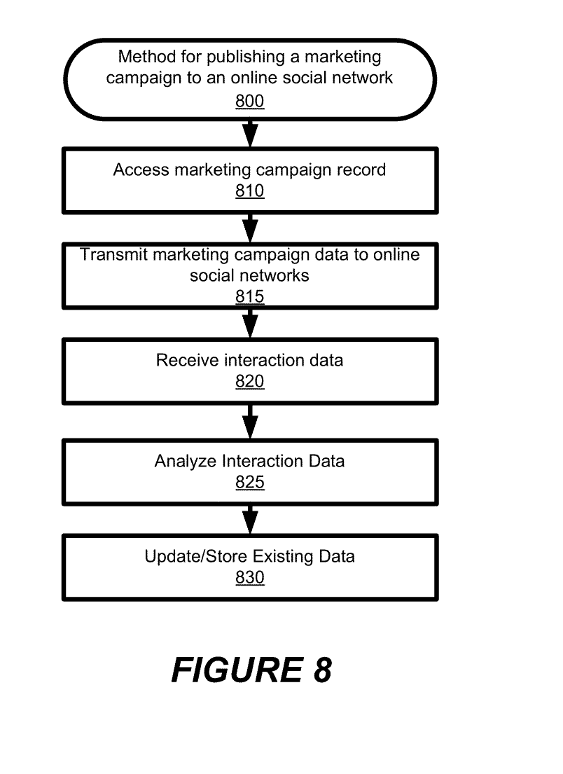

FIG. 8 shows a flowchart of an example of a method 800 for publishing a marketing campaign to an online social network based on data from a marketing campaign record according to some implementations. In block 810, marketing campaign information may be obtained, as previously discussed with blocks 310 and 410. In block 815, the marketing campaign data may be transmitted to multiple online social networks, as previously discussed. In block 820, interaction data may be received from the multiple online social networks.

In block 825, interaction data regarding the users interacting with the campaign on the online social network may be analyzed to determine whether to create or update contact records stored in CRM Database 120. For example, CRM Database 120 may include information, including emails, phone numbers, fax numbers, employment information, etc. regarding a particular individual. If the individual posts a comment in response to the online social marketing campaign, interaction data including the individual's information on their profile on the online social network may be received by Campaign Server 105. Accordingly, if the user on the online social network is determined to have a pre-existing contact record, the interaction data may be analyzed to determine whether to update or supplement the contact record with information in the interaction data.

For example, a contact record may have a timestamp associated with when the data in the fields of the record were last input. Interaction data may also have a timestamp associated with the contact information on the user's profile. If the timestamp associated with contact information from the profile is more recent than the contact information already existing in the database, then the information in CRM Database 120 may be updated with information in the interaction data in block 830. If the user does not have an existing contact record in CRM Database 120, then a new contact record may be created.

In another implementation, a contact record may be updated based on the source of the interaction data. For example, interaction data received from a business-oriented social network may be deemed to be reliable, and thus may be used to update an existing contact record in CRM Database 120. However, interaction data from a personal-oriented social network may not be used to update a contact record in CRM Database 120. In another implementation, the interaction data from the personal-oriented social network may be used to fill in missing data in a contact record, but not used to update existing data in the contact record.

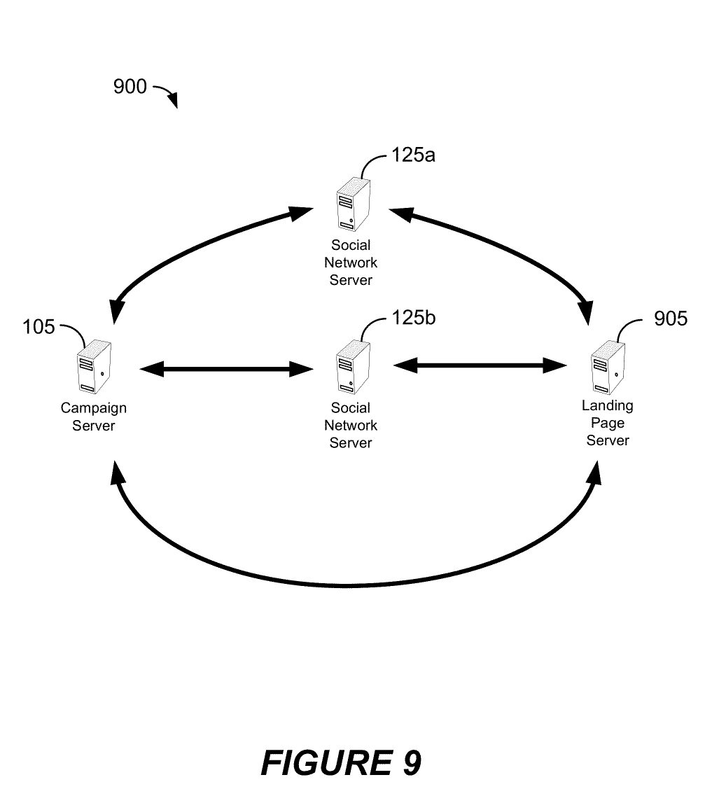

FIG. 9 shows a system diagram illustrating an example of architectural components 900 for publishing a marketing campaign to an online social network based on data from a marketing campaign record according to some implementations. Architectural components 900 in FIG. 9 may provide communications to be transmitted among a variety of different hardware and/or software components. For example, architectural components 900 may include components in FIGS. 1 and 2. In one implementation, architectural components 900 may include Campaign Server 105, Social Network Servers 125a and 125b, and Landing Page Server 905.

Landing Page Server 905 in FIG. 9 may host a website associated with the marketing campaign. Accordingly, a link to the website may be published on the online social networks hosted by Social Network Servers 125a and 125b. A user interacting with the campaign may use the link to receive more information regarding the campaign. In other implementations, the website on Landing Page Server 905 may have a form that may be filled and submitted. The details from the submitted form may be stored by Campaign Server 105 in CRM Database 120. For example, the form on Landing Page Server 905 may be configured to interface with a marketing campaign record or other record within CRM Database 120.

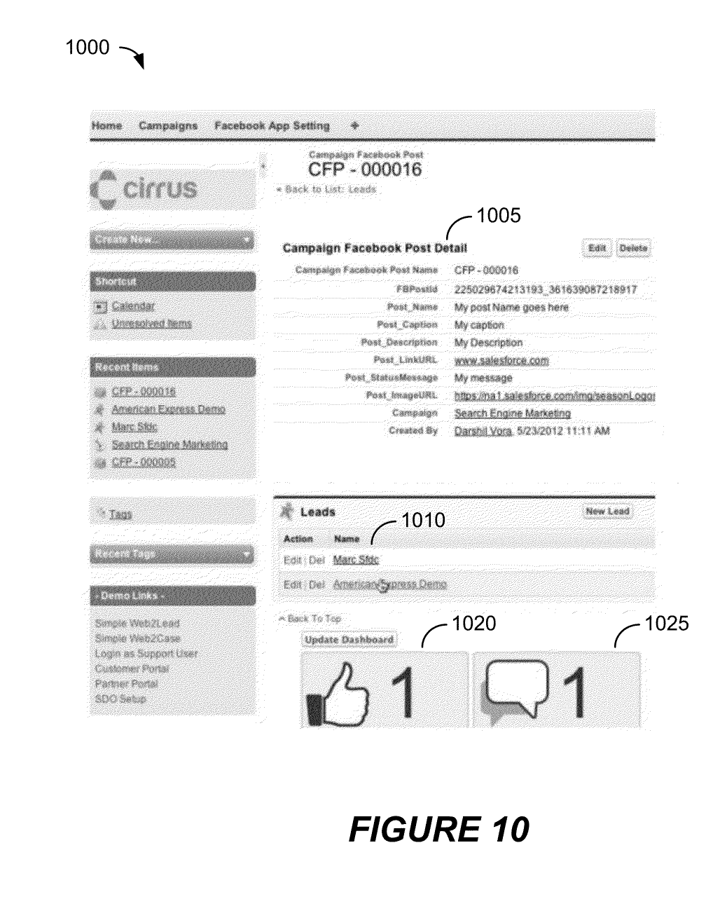

FIG. 10 shows an example of a Graphical User Interface (GUI) 1000 used to provide details on a marketing campaign record as displayed on a display device, such as one associated with a user of the CRM platform, according to some implementations. In FIG. 10, GUI 1000 includes Campaign Information 1005 and a variety of interaction data including Leads 1010, Likes Indicator 1020, and Comments 1025.

Campaign Information 1005 includes information regarding the online marketing campaign. In some implementations, Campaign Information 1005 may include all the types of data discussed in regard to FIG. 5. Additionally, Campaign Information 1005 may include information such as a timestamp associated with the publication of the campaign and identifiers associated with the campaign.

Leads 1010, Likes Indicator 1020, and Comments 1025 in GUI 1000 may show a variety of details associated with interaction data. For example, Leads 1010 may show details corresponding to users of the online social network who have interacted with the marketing campaign, as previously discussed. Likes Indicator 1020 may indicate the numbers of users of the online social network who have indicated that they “like” the marketing campaign published on the social network. Moreover, Comments 1025 may indicate the numbers of users of the online social network who have posted a message associated with the marketing campaign, as well as the content of the messages.

Though FIG. 10 shows campaign information for a single online marketing campaign posted to a single online social network, details corresponding to multiple sub-campaigns associated with a campaign may be aggregated into a single GUI. In some implementations, campaigns may have an aggregated GUI and each sub-campaign may also have its own GUI with its associated details.

Additional examples of systems, apparatus, and methods are disclosed herein for implementing enterprise level social and business information networking. Such implementations can provide more efficient use of a database system. For instance, a user of a database system may not easily know when important information in the database has changed, e.g., about a project or client. Implementations can provide feed tracked updates about such changes and other events, thereby keeping users informed.

By way of example, a user can update a record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed right to the manager's feed page or other page.

Mechanisms and methods for providing systems implementing enterprise level social and business information networking are disclosed herein with reference to several implementations. Examples of database systems are described and can provide a platform for tracking events related to a record, actions of a user, and messages about a user or record. The disclosed systems support various data structures of feeds, the customization of feeds, selection of records and users to follow, generation of feeds, and display of feeds in suitable presentations on a user's display device.

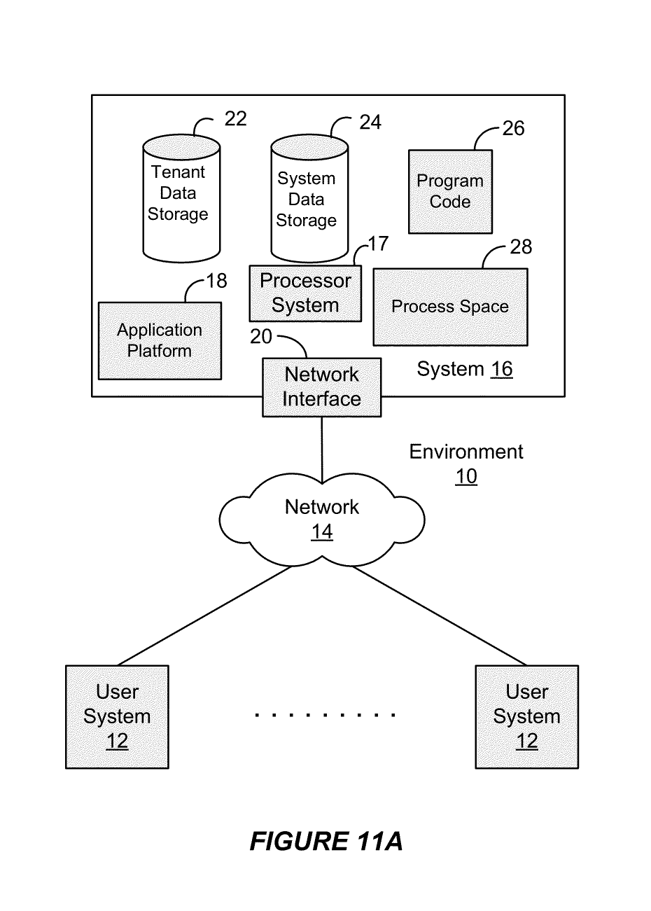

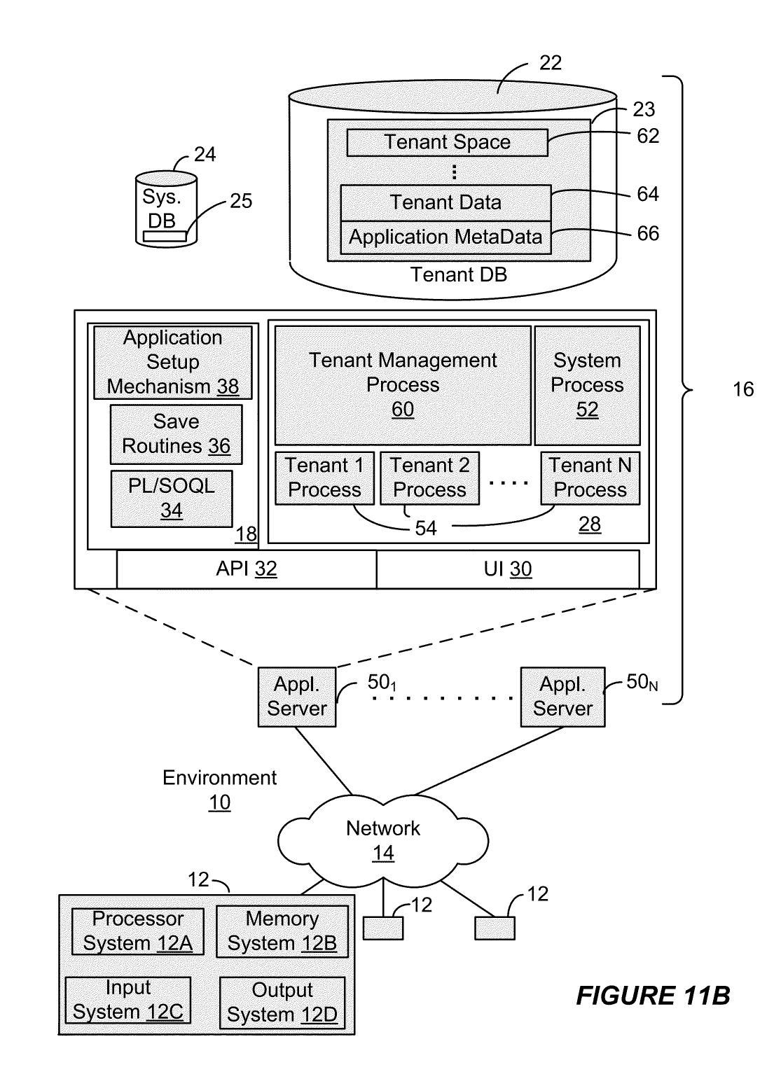

FIG. 11A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 11A (and in more detail in FIG. 11B) user systems 12 might interact via a network 14 with an on-demand database service, which is implemented in the example of FIG. 11A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 11A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 11A and 11B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 11A include conventional, well-known elements that are explained only briefly here. For example, each user system 12 could include a desktop personal computer, workstation, laptop, PDA, tablet, smartphone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 11B shows a block diagram of an example of some implementations of elements of FIG. 11A and various possible interconnections between these elements. That is, FIG. 11B also illustrates environment 10. However, in FIG. 11B elements of system 16 and various interconnections in some implementations are further illustrated. FIG. 11B shows that user system 12 may include processor system 12A, memory system 12B, input system 12C, and output system 12D. FIG. 11B shows network 14 and system 16. FIG. 11B also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 11A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 11B, system 16 may include a network interface 20 (of FIG. 11A) implemented as a set of HTTP application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

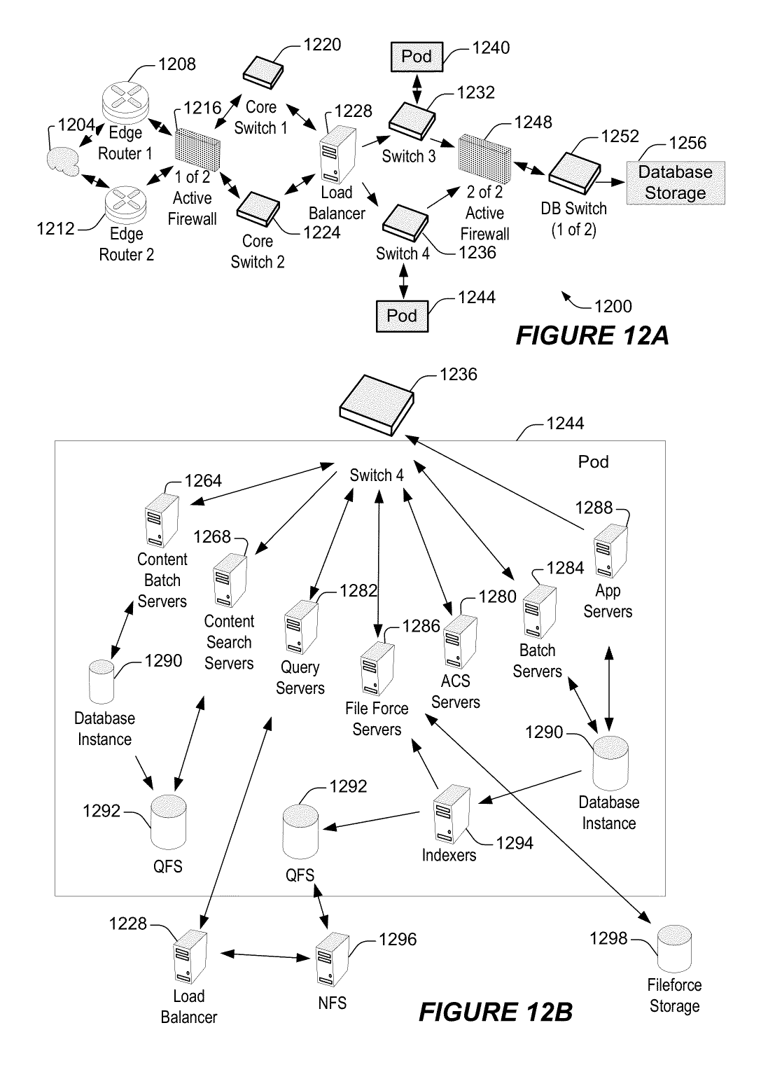

FIG. 12A shows a system diagram illustrating an example of architectural components of an on-demand database service environment 1200 according to some implementations. A client machine located in the cloud 1204, generally referring to one or more networks in combination, as described herein, may communicate with the on-demand database service environment via one or more edge routers 1208 and 1212. A client machine can be any of the examples of user systems 12 described above. The edge routers may communicate with one or more core switches 1220 and 1224 via firewall 1216. The core switches may communicate with a load balancer 1228, which may distribute server load over different pods, such as the pods 1240 and 1244. The pods 1240 and 1244, which may each include one or more servers and/or other computing resources, may perform data processing and other operations used to provide on-demand services. Communication with the pods may be conducted via pod switches 1232 and 1236. Components of the on-demand database service environment may communicate with a database storage 1256 via a database firewall 1248 and a database switch 1252.

As shown in FIGS. 12A and 12B, accessing an on-demand database service environment may involve communications transmitted among a variety of different hardware and/or software components. Further, the on-demand database service environment 1200 is a simplified representation of an actual on-demand database service environment. For example, while only one or two devices of each type are shown in FIGS. 12A and 12B, some implementations of an on-demand database service environment may include anywhere from one to many devices of each type. Also, the on-demand database service environment need not include each device shown in FIGS. 12A and 12B, or may include additional devices not shown in FIGS. 12A and 12B.

Moreover, one or more of the devices in the on-demand database service environment 1200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 1204 is intended to refer to a data network or plurality of data networks, often including the Internet. Client machines located in the cloud 1204 may communicate with the on-demand database service environment to access services provided by the on-demand database service environment. For example, client machines may access the on-demand database service environment to retrieve, store, edit, and/or process information.

In some implementations, the edge routers 1208 and 1212 route packets between the cloud 1204 and other components of the on-demand database service environment 1200. The edge routers 1208 and 1212 may employ the Border Gateway Protocol (BGP). The BGP is the core routing protocol of the Internet. The edge routers 1208 and 1212 may maintain a table of IP networks or ‘prefixes’, which designate network reachability among autonomous systems on the Internet.

In one or more implementations, the firewall 1216 may protect the inner components of the on-demand database service environment 1200 from Internet traffic. The firewall 1216 may block, permit, or deny access to the inner components of the on-demand database service environment 1200 based upon a set of rules and other criteria. The firewall 1216 may act as one or more of a packet filter, an application gateway, a stateful filter, a proxy server, or any other type of firewall.

In some implementations, the core switches 1220 and 1224 are high-capacity switches that transfer packets within the on-demand database service environment 1200. The core switches 1220 and 1224 may be configured as network bridges that quickly route data between different components within the on-demand database service environment. In some implementations, the use of two or more core switches 1220 and 1224 may provide redundancy and/or reduced latency.

In some implementations, the pods 1240 and 1244 may perform the core data processing and service functions provided by the on-demand database service environment. Each pod may include various types of hardware and/or software computing resources. An example of the pod architecture is discussed in greater detail with reference to FIG. 12B.

In some implementations, communication between the pods 1240 and 1244 may be conducted via the pod switches 1232 and 1236. The pod switches 1232 and 1236 may facilitate communication between the pods 1240 and 1244 and client machines located in the cloud 1204, for example via core switches 1220 and 1224. Also, the pod switches 1232 and 1236 may facilitate communication between the pods 1240 and 1244 and the database storage 1256.

In some implementations, the load balancer 1228 may distribute workload between the pods 1240 and 1244. Balancing the on-demand service requests between the pods may assist in improving the use of resources, increasing throughput, reducing response times, and/or reducing overhead. The load balancer 1228 may include multilayer switches to analyze and forward traffic.

In some implementations, access to the database storage 1256 may be guarded by a database firewall 1248. The database firewall 1248 may act as a computer application firewall operating at the database application layer of a protocol stack. The database firewall 1248 may protect the database storage 1256 from application attacks such as structure query language (SQL) injection, database rootkits, and unauthorized information disclosure.

In some implementations, the database firewall 1248 may include a host using one or more forms of reverse proxy services to proxy traffic before passing it to a gateway router. The database firewall 1248 may inspect the contents of database traffic and block certain content or database requests. The database firewall 1248 may work on the SQL application level atop the TCP/IP stack, managing applications' connection to the database or SQL management interfaces as well as intercepting and enforcing packets traveling to or from a database network or application interface.

In some implementations, communication with the database storage 1256 may be conducted via the database switch 1252. The multi-tenant database storage 1256 may include more than one hardware and/or software components for handling database queries. Accordingly, the database switch 1252 may direct database queries transmitted by other components of the on-demand database service environment (e.g., the pods 1240 and 1244) to the correct components within the database storage 1256.

In some implementations, the database storage 1256 is an on-demand database system shared by many different organizations. The on-demand database system may employ a multi-tenant approach, a virtualized approach, or any other type of database approach. An on-demand database system is discussed in greater detail with reference to FIGS. 11A and 11B.

FIG. 12B shows a system diagram further illustrating an example of architectural components of an on-demand database service environment according to some implementations. The pod 1244 may be used to render services to a user of the on-demand database service environment 1200. In some implementations, each pod may include a variety of servers and/or other systems. The pod 1244 includes one or more content batch servers 1264, content search servers 1268, query servers 1282, file force servers 1286, access control system (ACS) servers 1280, batch servers 1284, and app servers 1288. Also, the pod 1244 includes database instances 1290, quick file systems (QFS) 1292, and indexers 1294. In one or more implementations, some or all communication between the servers in the pod 1244 may be transmitted via the switch 1236.

In some implementations, the app servers 1288 may include a hardware and/or software framework dedicated to the execution of procedures (e.g., programs, routines, scripts) for supporting the construction of applications provided by the on-demand database service environment 1200 via the pod 1244. In some implementations, the hardware and/or software framework of an app server 1288 is configured to execute operations of the services described herein, including performance of the blocks of methods described with reference to FIGS. 1-10. In alternative implementations, two or more app servers 1288 may be included and cooperate to perform such methods, or one or more other servers described herein can be configured to perform the disclosed methods.

The content batch servers 1264 may handle requests internal to the pod. These requests may be long-running and/or not tied to a particular customer. For example, the content batch servers 1264 may handle requests related to log mining, cleanup work, and maintenance tasks.

The content search servers 1268 may provide query and indexer functions. For example, the functions provided by the content search servers 1268 may allow users to search through content stored in the on-demand database service environment.

The file force servers 1286 may manage requests for information stored in the Fileforce storage 1298. The Fileforce storage 1298 may store information such as documents, images, and basic large objects (BLOBs). By managing requests for information using the file force servers 1286, the image footprint on the database may be reduced.

The query servers 1282 may be used to retrieve information from one or more file systems. For example, the query system 1282 may receive requests for information from the app servers 1288 and then transmit information queries to the NFS 1296 located outside the pod.

The pod 1244 may share a database instance 1290 configured as a multi-tenant environment in which different organizations share access to the same database. Additionally, services rendered by the pod 1244 may call upon various hardware and/or software resources. In some implementations, the ACS servers 1280 may control access to data, hardware resources, or software resources.

In some implementations, the batch servers 1284 may process batch jobs, which are used to run tasks at specified times. Thus, the batch servers 1284 may transmit instructions to other servers, such as the app servers 1288, to trigger the batch jobs.

In some implementations, the QFS 1292 may be an open source file system available from Sun Microsystems® of Santa Clara, Calif. The QFS may serve as a rapid-access file system for storing and accessing information available within the pod 1244. The QFS 1292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 1268 and/or indexers 1294 to identify, retrieve, move, and/or update data stored in the network file systems 1296 and/or other storage systems.

In some implementations, one or more query servers 1282 may communicate with the NFS 1296 to retrieve and/or update information stored outside of the pod 1244. The NFS 1296 may allow servers located in the pod 1244 to access information to access files over a network in a manner similar to how local storage is accessed.

In some implementations, queries from the query servers 1222 may be transmitted to the NFS 1296 via the load balancer 1228, which may distribute resource requests over various resources available in the on-demand database service environment. The NFS 1296 may also communicate with the QFS 1292 to update the information stored on the NFS 1296 and/or to provide information to the QFS 1292 for use by servers located within the pod 1244.

In some implementations, the pod may include one or more database instances 1290. The database instance 1290 may transmit information to the QFS 1292. When information is transmitted to the QFS, it may be available for use by servers within the pod 1244 without using an additional database call.

In some implementations, database information may be transmitted to the indexer 1294. Indexer 1294 may provide an index of information available in the database 1290 and/or QFS 1292. The index information may be provided to file force servers 1286 and/or the QFS 1292.

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of the disclosed techniques can inform others (e.g., co-workers) who want to know about an update to a record automatically.

The tracking and reporting of updates to a record stored in a database system can be facilitated with a multi-tenant database system 16, e.g., by one or more processors configured to receive or retrieve information, process the information, store results, and transmit the results. In other implementations, the tracking and reporting of updates to a record may be implemented at least partially with a single tenant database system.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation.

Thus, the breadth and scope of the present application should not be limited by any of the implementations described herein, but should be defined only in accordance with the following and later-submitted claims and their equivalents.

What is claimed is:

1. A computer implemented method for publishing a marketing campaign using an online social network, the method comprising:
accessing, at a first server associated with a customer relationship management (CRM) platform, a marketing campaign record stored in association with a CRM database;
transmitting marketing campaign data from the marketing campaign record to a second server providing one or more services of a first online social network for publication of the marketing campaign data to one or more social media channels of the first online social network;
receiving, at the first server, interaction data from the second server, the interaction data indicating interactions of one or more users of the first online social network with the marketing campaign data; and
storing the interaction data on one or more storage mediums.

2. The method of claim 1, further comprising:
receiving, at the first server, at least a portion of the marketing campaign data to be stored in the marketing campaign record from a CRM object stored in the CRM database.

3. The method of claim 1, further comprising:
sending data to a display device associated with a user of the CRM platform to generate a user interface on the display device configured to receive user input to be included in the marketing campaign data, the user input including one or more of: a caption, a description, a message, a link to a file, a link to a web address, and an author name.

4. The method of claim 1, further comprising:
retrieving, at the first server, first online social network credentials from one or more storage mediums storing the credentials in association with the marketing campaign record; and
accessing, at the first server, the first online social network by providing the credentials to the second server.

5. The method of claim 1, wherein transmitting the marketing campaign data from the marketing campaign record to the second server includes using an application programming interface (API) associated with the first online social network.

6. The method of claim 1, wherein the interaction data includes one or more social media messages published to the one or more social media channels in response to the published marketing campaign data.

7. The method of claim 6, further comprising:
analyzing the one or more social media messages published to the one or more social media channels in response to the published marketing campaign data on the first online social network to determine a sentiment of the one or more social media messages.

8. The method of claim 7, further comprising:
determining that the one or more social media messages have a negative sentiment; and
creating or updating one or more CRM objects associated with the one or more social media messages to include the sentiment and at least a portion of the interaction data.

9. The method of claim 8, further comprising:
determining that a user of the first online social network associated with a social media message having a negative sentiment has a number of followers on the first online social network exceeding a predetermined threshold.

10. The method of claim 1, further comprising:
requesting, at the first server, the interaction data from the second server.

11. The method of claim 1, further comprising:
sending the interaction data to a display device associated with a user of the CRM platform.

12. The method of claim 1, wherein storing the interaction data includes:
creating or updating, at the first server, a CRM object stored in the CRM database to include at least a portion of the interaction data.

13. The method of claim 12, wherein the CRM object is one of: a case record, an account record, an opportunity record, a lead record, and a contact record.

14. The method of claim 1, wherein the interaction data includes information of a user profile of a user interacting with the published marketing campaign data, the user profile stored in association with the first online social network.

15. The method of claim 14, further comprising:
determining contact information from the user profile information;
identifying a CRM object stored in the CRM database that includes a first portion of the contact information; and
updating the CRM object to include a second portion of the contact information.

16. The method of claim 1, further comprising:
receiving, at the first server, publication data from the second server, the publication data identifying the marketing campaign data as published to the one or more social media channels, the publication data including one or more of: a post name, a post ID, a post caption, a post description, a post web address, post content, a post status, an author name, and a publication timestamp.

17. The method of claim 16, further comprising:
updating the marketing campaign record to include the received publication data.

18. The method of claim 1, wherein the interaction data identifies one or more geographic locations of the one or more users, as indicated by geo-location data provided by one or more mobile computing devices of the one or more users when accessing the first online social network.

19. The method of claim 1, wherein the interaction data further indicates one or more timeframes of the interactions of the one or more users of the first online social network.

20. The method of claim 19, wherein the publication of the marketing campaign on the one or more social media channels of the first online social network includes a link to a web address of a landing page configured to interface with the marketing campaign record.

21. The method of claim 1, wherein the marketing campaign data from the marketing campaign record is further transmitted to a third server providing one or more services of a second online social network for publication of the marketing campaign data to one or more social media channels of the second online social network.

22. The method of claim 21, wherein the marketing campaign data transmitted to the first online social network is a first set of data within the marketing campaign record and the marketing campaign data transmitted to the second online social network is a second set of data within the marketing campaign record, the first set being different from the second set.

23. The method of claim 1, wherein the interaction data includes a first identifier associated with the marketing campaign record and a second identifier associated with the publication of the marketing campaign data to the one or more social media channels of the first online social network.

24. One or more computing devices for publishing a marketing campaign using an online social network, the one or more computing devices comprising:
one or more processors operable to execute one or more instructions to:
access, at a customer relationship management (CRM) platform, a marketing campaign record stored in association with a CRM database,
provide marketing campaign data from the marketing campaign record for publication of the marketing campaign data to one or more social media channels of a first online social network,
receive interaction data indicating interactions of one or more users of the first online social network with the marketing campaign data, and
store the interaction data on one or more storage mediums.

25. A non-transitory computer-readable storage medium storing instructions executable by a computing device to perform a method for publishing a marketing campaign using an online social network, the method comprising:
accessing, at one or more servers associated with a customer relationship management (CRM) platform, a marketing campaign record stored in association with a CRM database;
providing marketing campaign data from the marketing campaign record for publication of the marketing campaign data to one or more social media channels of a first online social network;
receiving interaction data indicating interactions of one or more users of the first online social network with the marketing campaign data; and
storing the interaction data on one or more storage mediums.
